(19) United States
(12) Patent Application Publication
(10) Pub. No.: US 2020/0042643 A1
(43) Pub. Date: Feb. 6, 2020

(54) HEURISTIC Q&A SYSTEM

(71) Applicant: INTERNATIONAL BUSINESS MACHINES CORPORATION, ARMONK, NY (US)

(72) Inventors: Scott R. Carrier, Apex, NC (US); Brendan Bull, Durham, NC (US); Aysu Ezen Can, Wake, NC (US); Dwi Sianto Mansjur, Cary, NC (US)

(21) Appl. No.: 16/056,253

(22) Filed: Aug. 6, 2018

(51) Int. Cl. G06F 17/30; G06N 5/00; G06F 17/27; G10L 15/22

(52) U.S. Cl. CPC G06F 17/30654; G06N 5/003; G10L 2015/225; G06F 17/3069; G10L 15/22; G06F 17/2785

(57) ABSTRACT

Embodiments of the present invention disclose a method, a computer program product, and a computer system for providing heuristic answers to a question that cannot be answered with sufficient confidence. A computer receives a question and the computer identifies one or more answers to the question. In addition, the computer determines that a confidence level corresponding to the one or more answers does not exceed a threshold and, based on determining that the confidence level corresponding to the one or more answers does not exceed the threshold, the computer identifies a primary concept of the question. Moreover, the computer identifies one or more related concepts to the primary concept and reformulates the received question by replacing the primary concept with the one or more related concepts. Lastly, the computer identifies and presents to a user one or more reformulated answers to the reformulated question.

### BACKGROUND

The present invention relates generally to natural language processing, and more particularly to question and answering systems.

Automated question and answer (Q&A) systems are not always able to sufficiently answer a question received from a user. The answer to a question may not reside within the corpus, the language in which the answer is expressed may obfuscate its retrieval and ranking, etc. At worst, an incorrect answer is surfaced. At best, a system can acknowledge that it cannot sufficiently answer the question and perhaps direct the user to a search engine. This can result in an unsatisfying user experience.

### SUMMARY

Embodiments of the present invention disclose a method, a computer program product, and a computer system for a heuristic Q&A system. In embodiments, the invention includes a computer receiving a question and the computer identifying one or more answers to the question. In addition, the invention further includes the computer determining that a confidence level corresponding to the one or more answers does not exceed a threshold and, based on determining that the confidence level corresponding to the one or more answers does not exceed the threshold, the computer identifying a primary concept of the question. Moreover, the invention involves the computer identifying one or more related concepts to the primary concept and the computer reformulating the received question by replacing the primary concept with the one or more related concepts. Lastly, the invention includes the computer identifying one or more reformulated answers to the reformulated question.

In embodiments, the invention may further comprise the computer ranking the one or more reformulated answers and the computer presenting a highest ranked reformulated answer of the one or more reformulated answers to a user with a statement indicating that the highest ranked reformulated answer is a heuristic answer.

Moreover, in embodiments, identifying the one or more related concepts to the primary concept further comprises the computer mapping the primary concept to a vector space and the computer identifying the one or more related topics based on a word embedding distance within the vector space.

Furthermore, in embodiments, identifying the one or more related concepts to the primary concept further comprises the computer identifying a semantic type of the primary concept, the computer identifying a semantic type of the one or more related concepts, and the computer filtering at least one of the one or more related concepts based on the semantic type of the one or more related concepts mismatching the semantic type of the primary concept.

In some embodiments, identifying the primary concept of the question further comprises the computer classifying the question based on comparing the question to a set of patterns. Alternatively, in embodiments, identifying the primary concept of the question further comprises the computer applying one or more rules to the question.

In yet further embodiments, the invention may further include the computer prompting a user selection indicating whether the reformulated question was answered sufficiently by at least one of the reformulated one or more answers and adjusting the threshold based on the user selection.

### BRIEF DESCRIPTION OF THE SEVERAL VIEWS OF THE DRAWINGS

The following detailed description, given by way of example and not intended to limit the invention solely thereto, will best be appreciated in conjunction with the accompanying drawings, in which:

FIG. 1 depicts a schematic diagram of a heuristic Q&A system 100, in accordance with an embodiment of the present invention.

FIG. 2 depicts a flowchart illustrating the operations of a heuristic Q&A program 122 of the heuristic Q&A system 100 in providing a set of heuristic answers to a question that cannot be sufficiently answered by a Q&A system, in accordance with an embodiment of the present invention.

FIG. 3 depicts a block diagram depicting the hardware components of the heuristic Q&A system 100 of FIG. 1, in accordance with an embodiment of the present invention.

FIG. 4 depicts a cloud computing environment, in accordance with an embodiment of the present invention.

FIG. 5 depicts abstraction model layers, in accordance with an embodiment of the present invention.

The drawings are not necessarily to scale. The drawings are merely schematic representations, not intended to portray specific parameters of the invention. The drawings are intended to depict only typical embodiments of the invention. In the drawings, like numbering represents like elements.

### DETAILED DESCRIPTION OF THE SEVERAL VIEWS OF THE DRAWINGS

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

In the interest of not obscuring the presentation of embodiments of the present invention, in the following detailed description, some processing steps or operations that are known in the art may have been combined together for presentation and for illustration purposes and in some instances may have not been described in detail. In other instances, some processing steps or operations that are known in the art may not be described at all. It should be understood that the following description is focused on the distinctive features or elements of various embodiments of the present invention.

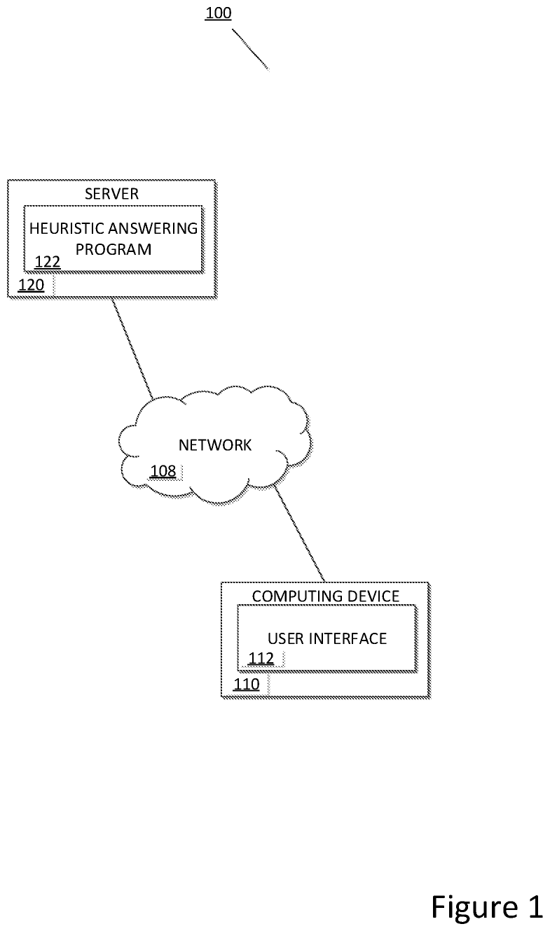

FIG. 1 depicts a heuristic Q&A system 100, in accordance with embodiments of the present invention. In the example embodiment, the heuristic Q&A system 100 includes a computing device 110 and a server 120, interconnected via a network 108. While, in the example embodiment, programming and data of the present invention are stored and accessed remotely across several servers via the network 108, in other embodiments, programming and data of the present invention may be stored locally on as few as one physical computing device or amongst other computing devices than those depicted.

In the example embodiment, the network 108 is a communication channel capable of transferring data between connected devices. In the example embodiment, the network 108 is the Internet, representing a worldwide collection of networks and gateways to support communications between devices connected to the Internet. Moreover, the network 108 may include, for example, wired, wireless, or fiber optic connections which may be implemented as an intranet network, a local area network (LAN), a wide area network (WAN), or a combination thereof. In further embodiments, the network 108 may be a Bluetooth network, a WiFi network, or a combination thereof. In yet further embodiments, the network 108 may be a telecommunications network used to facilitate telephone calls between two or more parties comprising a landline network, a wireless network, a closed network, a satellite network, or a combination thereof. In general, the network 108 can be any combination of connections and protocols that will support communications between the computing device 110 and the server 120.

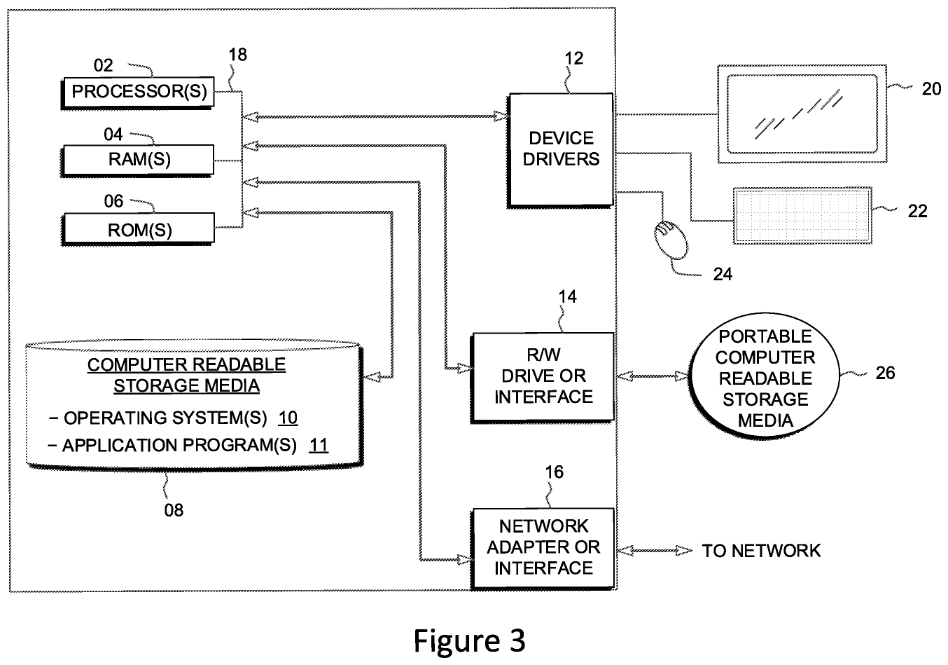

In the example embodiment, the computing device 110 includes user interface 112 and may be a server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, or any other electronic device or computing system capable of receiving and sending data to and from other computing devices. While, in the example embodiment, the computing device 110 is shown as a single device, in other embodiments, the computing device 110 may be comprised of a cluster or plurality of computing devices working together or working separately. The computing device 110 is described in further detail with reference to FIG. 3.

The user interface 112 is a software application which allows a user of computing device 110 to interact with the computing device 110 as well as other connected devices via the network 108. In addition, the user interface 112 may be connectively coupled to hardware components, such as those depicted by FIG. 3, for receiving user input, including mice, keyboards, touchscreens, microphones, cameras, and the like. In embodiments, the user interface 112 may be implemented via a standalone application or via partial or full integration with another application, for example through a web browsing application. Moreover, the user interface 112 may contain a graphical user interface (GUI) that is capable of transferring data files, folders, audio, video, hyperlinks, compressed data, and other forms of data transfer individually or in bulk.

In the example embodiment, the server 120 includes a heuristic Q&A program 122 and may be a server, a laptop computer, a notebook, a tablet computer, a netbook computer, a personal computer (PC), a desktop computer, a server, a personal digital assistant (PDA), a rotary phone, a touchtone phone, a smart phone, a mobile phone, a virtual device, a thin client, or any other electronic device or computing system capable of receiving and sending data to and from other computing devices. While, in the example embodiment, the computing device 110 is shown as a single device, in other embodiments, the computing device 110 may be comprised of a cluster or plurality of computing devices working together or working separately. The server 120 is described in greater detail with reference to FIG. 3.

The heuristic Q&A program 122 is a question and answer (Q&A) software application configured to receive one or more questions and provide one or more answers to the received questions. More specifically, the heuristic Q&A program 122 is capable of receiving a question and identifying one or more candidate answers to the question. In addition, the heuristic Q&A program 122 is capable of determining whether the question can be answered with sufficient confidence and, if not, identifying a primary concept of the question. Moreover, the heuristic Q&A program 122 is capable of identifying one or more concepts related to the primary concept and reformulating the question using the related concepts. If the heuristic Q&A program 122 determines that the reformulated question can be answered sufficiently using one or more of the related concepts, the heuristic Q&A program 122 is capable of returning the answer(s) to the reformulated question to the user. In some illustrative embodiments, the heuristic Q&A program 122 may be the Watson™ QA system available from International Business Machines Corporation of Armonk, N.Y.

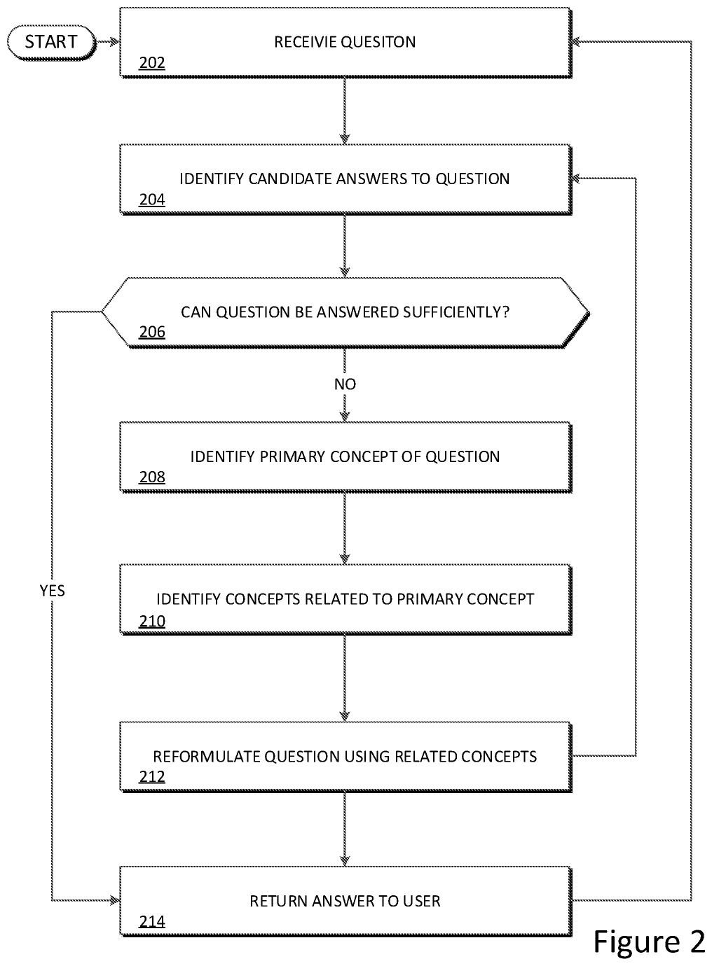

FIG. 2 illustrates the operations of the heuristic Q&A program 122 of the heuristic Q&A system 100 in providing one or more heuristic answers to a question that cannot be sufficiently answered by a traditional Q&A system.

The heuristic Q&A program 122 receives a question (step 202). In the example embodiment, the heuristic Q&A program 122 receives a question via the user interface 112 of the computing device 110 in the form of natural language, for example written or spoken human language, in an audio, video, or text file. The heuristic Q&A program 122 may then use methods to identify the question through techniques such as natural language processing, voice recognition, optical character recognition, and the like. In other embodiments, the heuristic Q&A program 122 may receive structured questions, for example questions written in structured query language (SQL).

For example, the heuristic Q&A program receives a spoken question from a user of computing device 110 that asks, “What is the recovery time for a synovectomy?”

The heuristic Q&A program 122 identifies one or more candidate answers to the received question (step 204). In the example embodiment, the heuristic Q&A program 122 first parses the question to extract the major features of the question, that in turn are then used to formulate queries that are applied to a corpus of data. Based on the application of the queries to the corpus of data, the heuristic Q&A program 122 generates a set of hypotheses, or candidate answers to the input question, by looking across the corpus of data for portions of the corpus of data that have some potential for containing a valuable or applicable response to the input question. The heuristic Q&A program 122 then performs deep analysis on the language of the input question and the language used in each of the portions of the corpus of data found during the application of the queries using a variety of reasoning algorithms. The heuristic Q&A program 122 may apply hundreds or even thousands of reasoning algorithms, each of which performs different analysis, e.g., comparisons, and generates a score. For example, some reasoning algorithms may look at the matching of terms and synonyms within the language of the input question and the found portions of the corpus of data. Other reasoning algorithms may look at temporal, syntactical, or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. The heuristic Q&A program 122 then weights each resulting score against a statistical model. The statistical model captures how well the reasoning algorithm performed at establishing the inference between two similar passages for a particular domain during the training period of the system. The statistical model may then be used to summarize a level of confidence that the system has regarding the evidence that the potential response, i.e. candidate answer, is inferred by the question. This process may be repeated for each of the candidate answers until the heuristic Q&A program 122 identifies candidate answers that surface as being significantly stronger than others and thus, generates a final answer, or ranked set of answers, for the input question.

In furthering the previously drawn out example, the heuristic Q&A program 122 identifies a candidate answer of four weeks with 56% confidence, a second candidate answer of two weeks with 44% confidence, and a third candidate answer of ten weeks with 27% confidence.

The heuristic Q&A program 122 determines whether the question can be answered with sufficient confidence (decision 206). In the example embodiment, the heuristic Q&A program 122 determines whether the question can be answered with sufficient confidence by determining whether any of the confidence scores for any candidate answer is greater than a preconfigured threshold. If so, the candidate answer is considered sufficient to answer the received question. In embodiments, the threshold may be absolute, for example 75% confidence, while in others the threshold may be relative, for example 15% greater than the confidence of the next most confident answer or group of answers. In further embodiments, the heuristic Q&A program 122 may use other techniques or metrics to determine whether the question has been answered sufficiently. For example, the heuristic Q&A program 122 may utilize a user feedback loop to adjust the confidence threshold as a moving target. For example, following step 214 wherein the heuristic Q&A program 122 returns an answer to the user, the heuristic Q&A program 122 may prompt a user selection indicating whether their question was sufficiently answered. Based on the received user response, the heuristic Q&A program 122 may adjust the confidence threshold, for example reducing the threshold if a low-confidence answer is identified as correct or increasing the threshold if a high-confidence answer is identified as incorrect.

Continuing the example illustrated above and assuming that a confidence score of 75% or above sufficiently answers the question, the heuristic Q&A program 122 compares the confidence levels of 56%, 44%, and 27% of the three respective candidate answers to the confidence level threshold of 75%.

If the heuristic Q&A program 122 determines the question cannot be answered sufficiently by the one or more candidate answers (decision 206 “NO” branch), the heuristic Q&A program 122 identifies a primary concept of the question (step 208). In embodiments, the heuristic Q&A program 122 may use classification techniques to identify the primary concept. In such embodiments, the question is classified into a set of predetermined patterns and employs different parse rules per pattern to ascertain the primary concept. For example, the heuristic Q&A program 122 may be configured to recognize the pattern, “What is the X of Y?”, and identify the primary concept as the first noun-phrase following the focus (X) of the question. In other embodiments, the heuristic Q&A program 122 may implement rule-based classification. In these embodiments, the heuristic Q&A program 122 may be preconfigured with rules to classify the data. For example, the heuristic Q&A program 122 may be preconfigured to classify a primary concept as the object of the preposition stemming from the focus of the question. Alternatively, the heuristic Q&A program 122 may be preconfigured to classify a primary concept as a noun-phrase concept closest to the focus of the question and the closest to an ontological edge. In yet further embodiments, the heuristic Q&A program 122 may implement machine learning or topic modelling to identify the primary concept. In general, the heuristic Q&A program 122 may use any known techniques for identifying the primary concept of the question.

In addition to identifying the primary concept, the heuristic Q&A program 122 may be further configured to identify a semantic type of the overlapping entity annotation of the primary concept. If there are more than one overlapping entity annotation of the primary concept, the heuristic Q&A program 122 utilizes concept disambiguation techniques to determine a most likely semantic type based on the surrounding context.

In furthering the previously drawn out example where the heuristic Q&A program 122 receives the question, “What is the recovery time for a synovectomy?”, the heuristic Q&A program 122 identifies the primary concept of the question as “synovectomy” by identifying the object of the preposition stemming from the focus of the question. In addition, the heuristic Q&A program 122 utilizes concept disambiguation to determine the most likely semantic type of synovectomy is a “therapeutic or preventive procedure”.

The heuristic Q&A program 122 identifies one or more concepts related to the primary concept, i.e., related concepts (step 210). In the example embodiment, the heuristic Q&A program 122 identifies related concepts using several known techniques, such as leveraging word embeddings to identify a set of candidate related concepts and an ontology to filter out candidate related concepts that are not of the same semantic type as the primary concept. In general, word embedding is the collective name for a set of language modelling and feature learning techniques in natural language processing (NLP) where words or phrases from the vocabulary are mapped to vectors of real numbers. In the example embodiment, word embedding techniques that use neural networks trained to reconstruct linguistic contexts of words are used to identify words related to the determined primary concept, as well as show how related each concept is.

With reference to the previously drawn out example, the heuristic Q&A program 122 identifies candidate related concepts illustrated by Table 1, below. Only the top ten results are shown below for brevity.

TABLE 1
Word Embedding and Embedding Distance

| | |
|---|---|
| Synoviorthesis | 0.854 |
| Synovectomies | 0.829 |
| Radiosynovectomy | 0.821 |
| Radiosynoviorthesis | 0.815 |
| Synovectomy of the knee | 0.807 |
| Total synovectomy | 0.802 |
| Partial synovectomy | 0.802 |
| Chronic synovitis | 0.777 |
| Arthrotomy | 0.764 |
| Pigmented villonodular synovitis | 0.763 |

In some embodiments, the heuristic Q&A program 122 may alternatively identify candidate related concepts in a similar manner to that above using an ontology distance rather than a word embeddings distance. Moreover, in further embodiments, the heuristic Q&A program 122 may identify candidate related concepts using both word embeddings and ontology distances by identifying candidate related concepts using word embedding distances and filtering out the candidate related concepts that are found to have a different semantic type than that of the primary concept.

In the example above, for instance, the heuristic Q&A program 122 may filter the results of Table 1, above, based on the semantic type of “therapeutic or preventative procedure”, thereby resulting in the list of candidate related concepts found in Table 2, below.

TABLE 2
Ontology Filtered Word Embedding and Embedding Distance

| | |
|---|---|
| Synoviorthesis | 0.854 |
| Synovectomies | 0.829 |
| Radiosynovectomy | 0.821 |
| Radiosynoviorthesis | 0.815 |
| Synovectomy of the knee | 0.807 |
| Total synovectomy | 0.802 |
| Partial synovectomy | 0.802 |
| Arthrotomy | 0.764 |

The heuristic Q&A program 122 reformulates the received question (step 212), substituting each of the candidate related concepts in place of the primary concept. In the example embodiment, the heuristic Q&A program 122 reformulates the question for each of the candidate related concepts. In other embodiments, however, the heuristic Q&A program 122 may only reformulate the question for one or more top candidate related concepts, for example using absolute or relative thresholds.

Continuing the previously introduced example, the heuristic Q&A program 122 replaces the primary concept originally found in the question, “synovectomy”, with the related concepts in Table 2. For example, one reformulated question may be, “What is the recovery time for a Synoviorthesis?”

The heuristic Q&A program 122 identifies one or more candidate answers to the one or more reformulated questions (step 204). In the example embodiment, the heuristic Q&A program 122 performs this step in a substantially similar manner to that above, except here the heuristic Q&A program 122 identifies candidate answers to the reformulated question rather than the originally received question.

Continuing the example set forth above, the heuristic Q&A program 122 identifies one or more candidate answers to the reformulated question of, “What is the recovery time for Synoviorthesis?”

The heuristic Q&A program 122 determines whether the reformulated question can be answered with sufficient confidence by at least one of the identified candidate answers (decision 206). Similar to that above, the heuristic Q&A program 122 determines whether the candidate answers sufficiently answer the question by comparing the confidence level in each of the candidate answers to a predefined threshold. In some embodiments, the heuristic Q&A program 122 may maintain a same confidence level threshold while, in others, the threshold may be reduced per iteration of the above steps in order to eventually provide an answer, albeit a low confidence answer.

If the heuristic Q&A program 122 determines the reformulated question can be answered sufficiently by one or more of the candidate answers (decision 206 “YES” branch), the heuristic Q&A program 122 returns the one or more candidate answers having the highest confidence level(s) to the user (step 214). In addition, the heuristic Q&A program 122 additionally provides a disclaimer indicating that the provided answer(s) are heuristic, as well as details regarding the relationship between the primary concept and each of the related concepts used in the answer(s). For example, the relationship details may include a similarity concept score and a confidence that each candidate answer sufficiently answers the reformulated question. In some embodiments, the heuristic Q&A program 122 may be configured to list a single, top candidate answer according to confidence level, while in others the heuristic Q&A program 122 may be configured to list several top answers or combine answers, or portions thereof, as needed and based on the received question. In embodiments, the heuristic Q&A program 122 may be configured to allow for selection of a similarity score by the user to view how it was computed, for example disclosing the calculated word imbedding scores and applied ontology filters. In addition, the heuristic Q&A program 122 may be further configured to allow for user selection of a corresponding answer which, in response to user selection, discloses the evidence from the corpus used in deducing the displayed answer.

In completing the carried-through example above, the heuristic Q&A program 122 retunes to the user, “The question and answering system was unable to deduce an answer of sufficient confidence for the question relating to a ‘synovectomy’. The question and answering system, however, found that the recovery time of an Synoviorthesis was two weeks.” In addition, the heuristic Q&A program 122 may provide the list of top candidate answers, for example indicating that Synoviorthesis is the next most suitable substitute concept for a Synovectomy with a similarity concept score of 0.85, a confidence level of “high”, and an answer of 2.5 weeks.

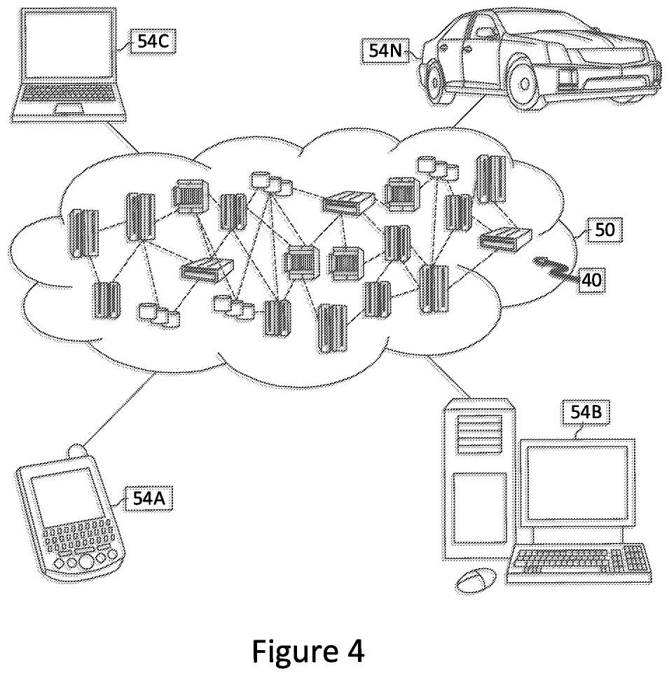

FIG. 3 depicts a block diagram of the server 120 and the computing device 110 of the heuristic Q&A system 100 of FIG. 1, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Computing device 110 may include one or more processors 02, one or more computer-readable RAMs 04, one or more computer-readable ROMs 06, one or more computer readable storage media 08, device drivers 12, read/write drive or interface 14, network adapter or interface 16, all interconnected over a communications fabric 18. Communications fabric 18 may be implemented with any architecture designed for passing data and/or control information between processors (such as microprocessors, communications and network processors, etc.), system memory, peripheral devices, and any other hardware components within a system.

One or more operating systems 10, and one or more application programs 11, for example interaction prediction program 142, are stored on one or more of the computer readable storage media 08 for execution by one or more of the processors 02 via one or more of the respective RAMs 04 (which typically include cache memory). In the illustrated embodiment, each of the computer readable storage media 08 may be a magnetic disk storage device of an internal hard drive, CD-ROM, DVD, memory stick, magnetic tape, magnetic disk, optical disk, a semiconductor storage device such as RAM, ROM, EPROM, flash memory or any other computer-readable tangible storage device that can store a computer program and digital information.

Computing device 110 may also include a R/W drive or interface 14 to read from and write to one or more portable computer readable storage media 26. Application programs 11 on said devices may be stored on one or more of the portable computer readable storage media 26, read via the respective R/W drive or interface 14 and loaded into the respective computer readable storage media 08.

Computing device 110 may also include a network adapter or interface 16, such as a TCP/IP adapter card or wireless communication adapter (such as a 4G wireless communication adapter using OFDMA technology). Application programs 11 on said computing devices may be downloaded to the computing device from an external computer or external storage device via a network (for example, the Internet, a local area network or other wide area network or wireless network) and network adapter or interface 16. From the network adapter or interface 16, the programs may be loaded onto computer readable storage media 08. The network may comprise copper wires, optical fibers, wireless transmission, routers, firewalls, switches, gateway computers and/or edge servers.

Computing device 110 may also include a display screen 20, a keyboard or keypad 22, and a computer mouse or touchpad 24. Device drivers 12 interface to display screen 20 for imaging, to keyboard or keypad 22, to computer mouse or touchpad 24, and/or to display screen 20 for pressure sensing of alphanumeric character entry and user selections. The device drivers 12, R/W drive or interface 14 and network adapter or interface 16 may comprise hardware and software (stored on computer readable storage media 08 and/or ROM 06).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Based on the foregoing, a computer system, method, and computer program product have been disclosed. However, numerous modifications and substitutions can be made without deviating from the scope of the present invention. Therefore, the present invention has been disclosed by way of example and not limitation.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

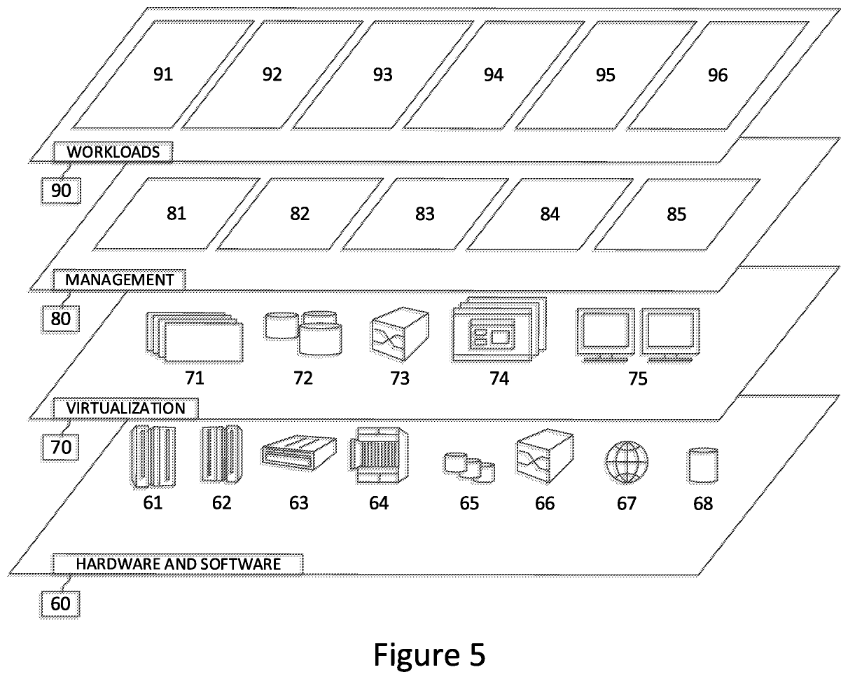

Referring now to FIG. 5, illustrative cloud computing environment 50 is depicted. As shown, cloud computing environment 50 includes one or more cloud computing nodes 40 with which local computing devices used by cloud consumers, such as, for example, personal digital assistant (PDA) or cellular telephone 54A, desktop computer 54B, laptop computer 54C, and/or automobile computer system 54N may communicate. Nodes 40 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 40 and cloud computing environment 50 can communicate with any type of computerized device over any type of network and/or network addressable connection (e.g., using a web browser).

Referring now to FIG. 5, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and Q&A system 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method for providing heuristic answers to a question that cannot be answered with sufficient confidence, the method comprising:
a computer receiving a question;
the computer identifying one or more answers to the question;
the computer determining that a confidence level corresponding to the one or more answers does not exceed a threshold;
based on determining that the confidence level corresponding to the one or more answers does not exceed the threshold, the computer identifying a primary concept of the question;
the computer identifying one or more related concepts to the primary concept;
the computer reformulating the received question by replacing the primary concept with the one or more related concepts; and
the computer identifying one or more reformulated answers to the reformulated question.

2. The method of claim 1, further comprising:
the computer ranking the one or more reformulated answers; and
the computer presenting a highest ranked reformulated answer of the one or more reformulated answers to a user with a statement indicating that the highest ranked reformulated answer is a heuristic answer.

3. The method of claim 1, wherein identifying the one or more related concepts to the primary concept further comprises:
the computer mapping the primary concept to a vector space; and
the computer identifying the one or more related topics based on a word embedding distance within the vector space.

4. The method of claim 1, wherein identifying the one or more related concepts to the primary concept further comprises:
the computer identifying a semantic type of the primary concept; and
the computer identifying a semantic type of the one or more related concepts; and
the computer filtering at least one of the one or more related concepts based on the semantic type of the one or more related concepts mismatching the semantic type of the primary concept.

5. The method of claim 1, wherein identifying the primary concept of the question further comprises:
the computer classifying the question based on comparing the question to a set of patterns.

6. The method of claim 1, wherein identifying the primary concept of the question further comprises:
the computer applying one or more rules to the question.

7. The method of claim 2, further comprising:
the computer prompting a user selection indicating whether the reformulated question was answered sufficiently by at least one of the reformulated one or more answers; and
adjusting the threshold based on the user selection.

8. A computer program product for proving heuristic answers to a question that cannot be answered with sufficient confidence, the computer program product comprising:
one or more computer-readable storage media and program instructions stored on the one of more computer-readable storage media, the program instructions comprising:
program instructions to receive a question;
program instructions to identify one or more answers to the question;
program instructions to determine that a confidence level corresponding to the one or more answers does not exceed a threshold;
based on determining that the confidence level corresponding to the one or more answers does not exceed the threshold, program instructions to identify a primary concept of the question;
program instructions to identify one or more related concepts to the primary concept;
program instructions to reformulate the received question by replacing the primary concept with the one or more related concepts; and
program instructions to identify one or more reformulated answers to the reformulated question.

9. The computer program product of claim 8, further comprising:
program instructions to rank the one or more reformulated answers; and
program instructions to present a highest ranked reformulated answer of the one or more reformulated answers to a user with a statement indicating that the highest ranked reformulated answer is a heuristic answer.

10. The computer program product of claim 8, wherein the program instructions to identify the one or more related concepts to the primary concept further comprises:
program instructions to map the primary concept to a vector space; and
program instructions to identify the one or more related topics based on a word embedding distance within the vector space.

11. The computer program product of claim 8, wherein the program instructions to identify the one or more related concepts to the primary concept further comprises:
program instructions to identify a semantic type of the primary concept; and
program instructions to identify a semantic type of the one or more related concepts; and
program instructions to filter at least one of the one or more related concepts based on the semantic type of the one or more related concepts mismatching the semantic type of the primary concept.

12. The computer program product of claim 8, wherein the program instructions to identify the primary concept of the question further comprises:
program instructions to classify the question based on comparing the question to a set of patterns.

13. The computer program product of claim 8, wherein the program instructions to identify the primary concept of the question further comprises:
the computer applying one or more rules to the question.

14. The computer program product of claim 9, further comprising:
the computer prompting a user selection indicating whether the reformulated question was answered sufficiently by at least one of the reformulated one or more answers; and
adjusting the threshold based on the user selection.

15. A computer system for providing heuristic answers to a question that cannot be answered with sufficient confidence, the computer system comprising:
one or more computer processors, one or more computer-readable storage media, and program instructions stored on one or more of the computer-readable storage media for execution by at least one of the one or more processors, the program instructions comprising:
program instructions to receive a question;
program instructions to identify one or more answers to the question;
program instructions to determine that a confidence level corresponding to the one or more answers does not exceed a threshold;
based on determining that the confidence level corresponding to the one or more answers does not exceed the threshold, program instructions to identify a primary concept of the question;
program instructions to identify one or more related concepts to the primary concept;
program instructions to reformulate the received question by replacing the primary concept with the one or more related concepts; and
program instructions to identify one or more reformulated answers to the reformulated question.

16. The computer system of claim 15, further comprising:
program instructions to rank the one or more reformulated answers; and
program instructions to present a highest ranked reformulated answer of the one or more reformulated answers to a user with a statement indicating that the highest ranked reformulated answer is a heuristic answer.

17. The computer system of claim 15, wherein the program instructions to identify the one or more related concepts to the primary concept further comprises:
program instructions to map the primary concept to a vector space; and
program instructions to identify the one or more related topics based on a word embedding distance within the vector space.

18. The computer system of claim 15, wherein the program instructions to identify the one or more related concepts to the primary concept further comprises:
program instructions to identify a semantic type of the primary concept; and
program instructions to identify a semantic type of the one or more related concepts; and
program instructions to filter at least one of the one or more related concepts based on the semantic type of the one or more related concepts mismatching the semantic type of the primary concept.

19. The computer system of claim 15, wherein the program instructions to identify the primary concept of the question further comprises:
program instructions to classify the question based on comparing the question to a set of patterns.

20. The computer system of claim 16, further comprising:
program instructions to prompt a user selection indicating whether the reformulated question was answered sufficiently by at least one of the reformulated one or more answers; and
program instructions to adjust the threshold based on the user selection.
